(19) United States
(12) Patent Application Publication
(10) Pub. No.: US 2022/0132076 A1
(43) Pub. Date: Apr. 28, 2022

(54) HOTSPOT ACCESSORY CAMERA SYSTEM

(71) Applicant: INSEEGO CORP., San Diego, CA (US)

(72) Inventors: DAN PICKER, San Diego, CA (US); Ashish SHARMA, San Diego, CA (US); Kasturi RANGAM, San Diego, CA (US); Sean KIM, San Diego, CA (US); Pedro GUTIERREZ, San Diego, CA (US); Bill BABBITT, San Diego, CA (US)

(21) Appl. No.: 17/082,633

(22) Filed: Oct. 28, 2020

(51) Int. Cl. H04N 7/18; G06K 9/00; H04N 5/225; H04W 76/10

(52) U.S. Cl. CPC H04N 7/183; G06K 9/00624; H04W 84/18; G06K 9/00255; H04W 76/10; H04N 5/2253

(57) ABSTRACT

A hotspot accessory camera connectable to a hotspot via a physical connection is provided. The hotspot accessory camera may include edge processing and/or artificial intelligence capabilities for image/video processing of images/video captured by the hotspot accessory camera. The hotspot accessory camera may include a base that accepts a hotspot device, and at least one actuatable arm adapted to hold one or more cameras to effectuate image/video capture.

### DESCRIPTION OF RELATED ART

Wireless communications have become ubiquitous in today's society, and as wireless systems capabilities increase, so does the adoption rate of wireless technologies. Today, wireless technologies are fast overtaking and replacing conventional wired technologies and infrastructure.

### BRIEF SUMMARY OF THE DISCLOSED TECHNOLOGY

In accordance with one embodiment, a method may comprise capturing at least one image or frame of a real-world scene by an accessory camera operatively connected to a hotspot. Moreover, the method may comprise analyzing the at one image or frame to detect one or more objects in the real-world scene, and applying at least one of filtering and preferential selection of the one or more objects of interest. Further still, the method may comprise transmitting information regarding the filtered or preferred one or more objects of interest to a remotely located server via the hotspot, and receiving, at the hotspot, from the remotely located server, a map of the real-world scene generated using and comprising the filtered or preferred one or more objects of interest.

In some embodiments, the one or more detected objects include, in part, occluding objects impeding line-of-sight connectivity between the hotspot and a 5G small cell. In some embodiments, the application of the at least one of filtering and preferential selection comprises identifying only the occluding objects. In some embodiments, the method may further comprise caching the occluding objects in a memory of at least one of the hotspot and the accessory camera.

In accordance with another embodiment, a hotspot accessory camera system may comprise a hotspot, and an accessory camera operatively connected to the hotspot. In some embodiments, the accessory camera may comprise: a support platform supporting a surface of the hotspot thereon; at least one retaining member securedly retaining the hotspot to the support platform; a hotspot connector mating with an accessory camera connector port effectuating a data connection between the hotspot and the accessory camera; an actuatable arm; and a camera unit disposed in the actuatable arm capturing at least one of images and frames, wherein at least a subset of the at least one of the images and frames are received by the hotspot for transmission to a remote server via a communications connection effectuated between the hotspot and a wireless communications network.

In some embodiments, the camera unit comprises first and second camera lenses oriented to capture the at least one of the images and frames from at least two directions. In some embodiments, the accessory camera further comprises at least one processor adapted to perform edge processing at the accessory camera prior to the transferring of the at least one of the images and frames to the remote server. In some embodiments, the at least one processor adapted to perform the edge processing filters one or more of the at least one of the images and frames. In some embodiments, the subset of the at least one of the images and frames comprises those of the one or more of the at least one of the images and frames remaining after the filtering by the at least one processor. In some embodiments, the at least one processor is further adapted to cache the subset of the at least one of the images and frames in a memory of at least one of the hotspot and the accessory camera. In some embodiments, the at least one of the images and frames includes facial captures from one or more users of the hotspot accessory camera system. In some embodiments, the at least one processor adapted to perform the edge processing filters the at least one of the images and frames to store only those of the at least one of the images and frames corresponding to the facial captures from the one or more users of the hotspot accessory camera system. In some embodiments, the hotspot transmits the facial captures from the one or more users of the hotspot accessory camera system to the remote server to authenticate the one or more users.

In some embodiments, the accessory camera further comprises one or more sensors sensing biometric-related characteristics of one or more users of the hotspot accessory camera system. In some embodiments, the processor is further adapted to relate the biometric-related characteristics of the one or more users to the at least one of the images and frames. In some embodiments, the hotspot receives targeted data for presentation to the one or more users based on the relationship between the biometric-related characteristics and the at least one of the images and frames.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example 5G network with which various embodiments of the present disclosure may be implemented.

FIG. 2A illustrates a conventional system in which a hotspot may be utilized.

FIG. 2B illustrates a system in which a hotspot accessory camera system may be utilized in accordance with some embodiments.

FIG. 3A is a block diagram of an example hotspot in accordance with some embodiments.

FIG. 3B is a block diagram of an example accessory camera in accordance with some embodiments.

FIG. 4A illustrates an example accessory camera in accordance with one embodiment.

FIG. 4B illustrates an overhead perspective view of an example hotspot accessory camera system in accordance with one embodiment.

FIG. 4C illustrates a rear perspective view of an example accessory camera system in an on state in accordance with one embodiment.

FIG. 4D illustrates a rear perspective view of the example accessory camera system of FIG. 4C in an off state in accordance with one embodiment.

FIG. 4E illustrates a rear perspective view of an example accessory camera system in an on state in accordance with one embodiment.

FIG. 4F illustrates a rear perspective view of the example accessory camera system of FIG. 4E in an off state in accordance with one embodiment.

FIG. 5 is a flow chart illustrating example operations that may be performed by hotspot accessory camera system in accordance with one embodiment for map generation.

FIG. 6 illustrates an example of an example computing component that may be used in implementing various features of embodiments of the disclosed technology.

The figures are not exhaustive and do not limit the disclosure or the disclosed embodiments to the precise form disclosed.

### DETAILED DESCRIPTION OF THE EMBODIMENTS

Wireless communications technology, such as 5G, promises faster data speeds and lower latency. The 5G broadcast transmission protocol devised by the 3^{rd} Generation Partnership Project (3GPP) represents the latest in wireless communication technologies promising to revolutionize wireless data communications. 5G high-band technologies utilize extremely high frequency (EHF), or millimeter wave, that enables connectivity significantly improved over the previous generation 4G networks. 5G provides greater spectral efficiency and greater spectrum pathways to achieve increased throughput for each part of the spectrum.

While millimeter wave frequencies allow greater bandwidth, these frequencies suffer from decreased range as compared to their longer wavelength, lower frequency predecessors. Millimeter wave frequencies also suffer from greater attenuation when traveling through walls, windows and other structural components. Accordingly, 5G networks typically require a higher density of transmitters as compared to 4G network architectures.

Hotspots or mobile routers can refer to devices that can be used to access an internet/the Internet on a variety of devices, e.g., smartphones, laptop PCs, etc. without being tethered to a typical, stationary router installed in homes, businesses, offices, etc. That is, hotspots can use cellular data, e.g., 5G cellular data, to provide internet access. Typically, a hotspot is a compact, battery-powered WiFi station that taps into a cellular network, such as the aforementioned 5G network, and shares (wirelessly) its data connection with other WiFi-enabled devices.

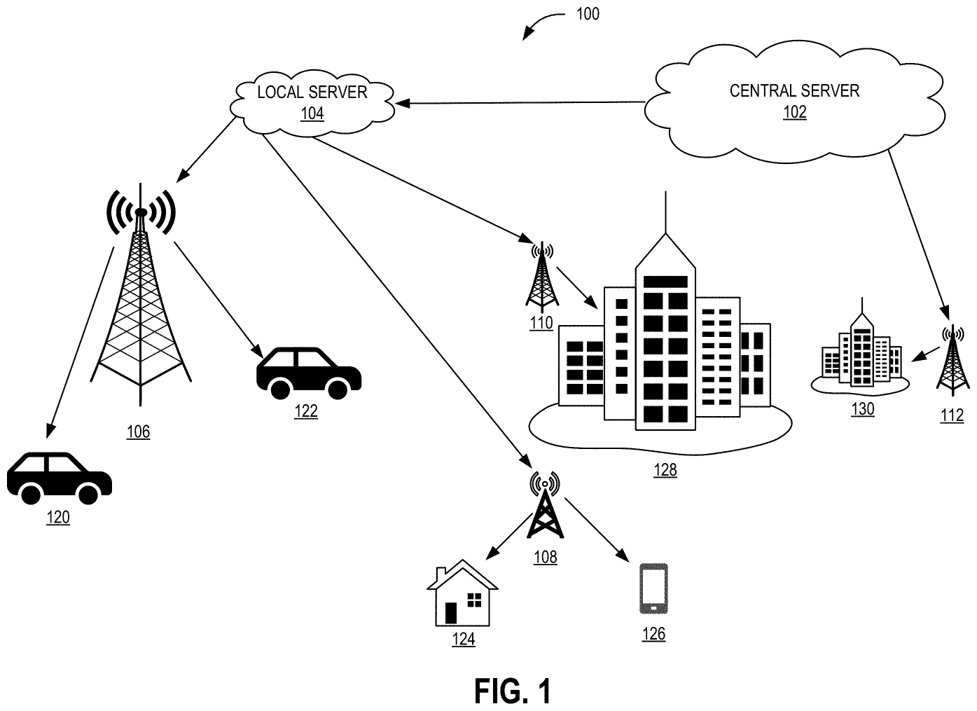

Before describing example embodiments in detail, it is useful to describe an example environment with which various embodiments may be implemented. FIG. 1 illustrates an example 5G network 100 in which or with which various embodiments of the present disclosure may be implemented. 5G is a standard promulgated by the International Telecommunication Union (ITU) and the 3^{rd} Generation Partnership Project (3GPP), with the ITU setting the minimum requirements for 5G compliance, and the 3GPP creating the corresponding specifications. 5G is a successor to the 4G/Long Term Evolution (LTE) standard, and refers to the fifth generation of wireless broadband technology for digital cellular networks. 5G is intended to replace or augment 4G/LTE. Touted advantages of 5G include, for example, up to 10 times faster download and upload speeds, along with much-reduced latency (also referred to as “air latency,” i.e., the roundtrip time it takes for a device to communicate with the network).

The frequency spectrum of 5G includes three bands. The first band can be referred to as the low-band spectrum, i.e., the sub-1 GHz spectrum. This low-band spectrum is the primary band used by U.S. wireless carriers with data speeds reaching about 100 Mbps. The second band can be referred to as the mid-band spectrum, i.e., the sub-6 GHz spectrum, which provides lower latency (e.g., 4-5 ms) and greater data speeds (e.g., up to 1 Gbps) relative to the low-band spectrum. However, mid-band signals are not able to penetrate structures, such as buildings, as effectively as low-band signals. The third band can be referred to as the high-band spectrum, or millimeter wave (mmWave), and operates between 25 GHz and 100 GHz. The term millimeter is associated with this high-band spectrum because wavelengths in this portion of the spectrum range from, e.g., 1-10 mm. Devices operating on this third band can deliver the highest data speed (e.g., up to 10 Gbps) and the lowest latency (e.g., 1 ms). However, its coverage area (the distance it can transfer data) is less than that of the low-band and mid-band spectrums, and building penetration decreases as the frequency increases. Use of mmWave technology is nevertheless desirable because the low-band and mid-band portions of the spectrum are already heavily congested with, e.g., TV and radio signals, as well as 4G/LTE traffic, and so long as the coverage area can be limited, the benefits of mmWave technology can still be realized.

With reference now to FIG. 1, a mobile network's RAN may include various infrastructure, e.g., base stations/cell towers, masts, in-home/in-building infrastructure, and the like. The RAN allows users of mobile devices, e.g., smartphones, tablet computers, laptops, vehicle-implemented communication devices (e.g., vehicles having vehicle-to-vehicle (V2V) capabilities), to the core network. The example of FIG. 1 illustrates a plurality of 5G small base stations or small cells and 5G macro base stations or macro cells, i.e., 5G macro cells 106, 110, and 112, and 5G small cell 108.

Macro cells can refer to (tall, high-powered) “macro” base stations/cell towers that are able to maintain network signal strength across long/large distances. 5G macro cells may use multiple input, multiple output (MIMO) antennas that may have various components that allow data to be sent and/or received simultaneously. In the example 5G network 100 of FIG. 1, 5G macro cell 106 may provide wireless broadband coverage/communications to vehicles 120 and 122. 5G macro cell 110 may provide broadband service to an area, such as a city or municipality 128. Likewise, 5G macro cell 112 may provide broadband coverage to an area, such as a city or municipality 130. The MIMO antennas used by 5G macro cells may comprise large numbers of antenna elements, which can be referred to as massive MIMO, whose size may be comparable to, e.g., 3G and/or 4G base station antennas.

5G small cells can refer to wireless transmitters/receivers implemented as micro base stations designed to provide coverage to areas smaller than those afforded coverage by 5G macro cells, e.g., on the order of about 100 m to 200 m for outdoor 5G small cells. Indoor 5G small cell deployments may be on the order about 10 m. 5G small cells can be mounted or integrated into/onto street lights, utility poles, buildings, etc., and like 5G macro cells, may also leverage massive MIMO antennas. In the example 5G network 100 of FIG. 1, 5G small cell 108 provides broadband coverage to a house 124 and smartphone 126.

The core network may comprise the mobile exchange and data network used to manage the connections made to/from/via the RAN. As illustrated in FIG. 1, the core network of 5G network 100 may include central server 102 and local server 104. Central server 102 is shown to effectuate broadband service to municipality 130 by way of 5G macro cell 112. Central server 102 may also operatively connect to local server 104, which in turn, provides broadband connectivity by way of 5G macro cells 106 and 110, as well as 5G small cell 108. The use of distributed servers, such as local server 104 can improve response times, thereby reducing latency. The core network may leverage network function virtualization (instantiation of network functions using virtual machines via the cloud rather than hardware) and network slicing (segmentation of 5G network 100 in accordance with a particular application, industry, or other criteria) to provide these lower response times, and provide faster connectivity.

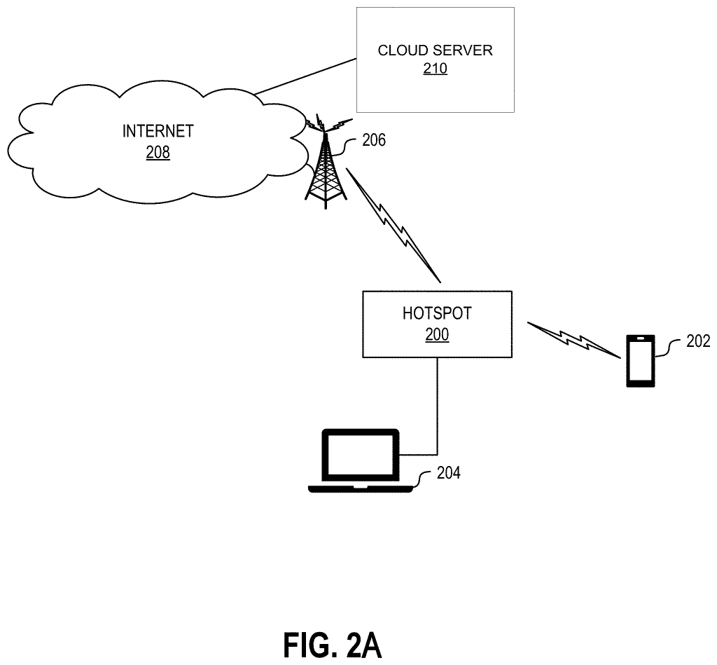

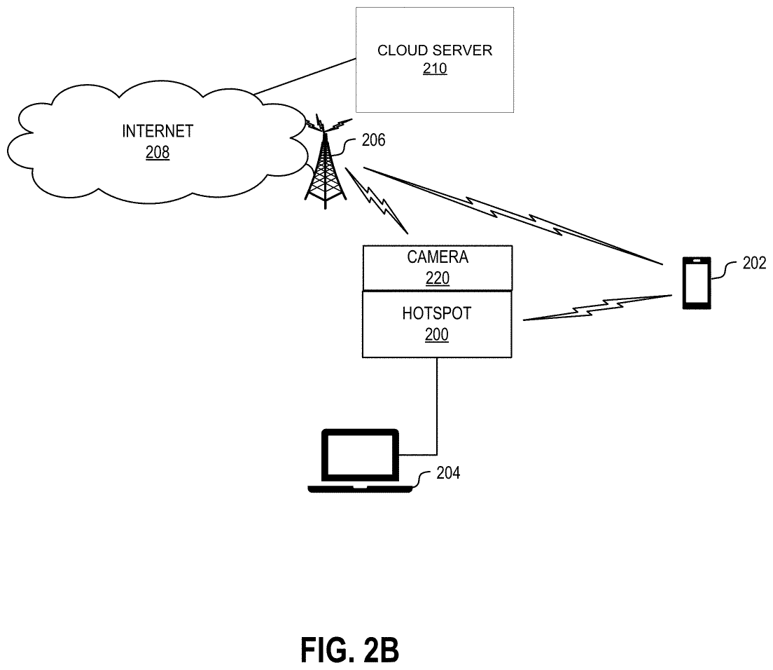

FIG. 2 illustrates an example of a typical hotspot or mobile router implementation. In FIG. 2, hotspot 200 provides internet connectivity to user devices 202, 204 (or other WiFi-capable devices not shown) through a wireless local area network (WLAN) protocol, such as IEEE 802.11 or WiFi protocols. User devices 202, 204 may include, for example, a laptop, desktop, portable phone, personal digital assistant (PDA), smart phone or any other device capable of wireless communication. The number of devices which can be supported by hotspot 200 may vary and may be determined by software, firmware or the like within hotspot 200.

Hotspot 200 can be configured to communicate with a service provider through, for example, a cellular base station 206 associated with a wireless communication network, such as a wireless wide area network (WWAN) (e.g., 5G network). Through the wireless communication network, access to a communication network such as the Internet 208 may be provided. Any of a number of servers (e.g., cloud server 210) may be accessed by a user device through hotspot 200 and communication network 208.

As alluded to above, wireless communications have become ubiquitous along with the use of smartphones that typically have built-in cameras. Due to their size, thermal design, and construction, smartphones tend to throttle down data rates they are able to sustain quickly. On the other hand, hotspots, such as hotspot 200, are generally designed specifically to sustain high data rates for longer periods of time, again, typically converting cellular data signals (e.g., 4G or 5G) into WiFi signals for connection to user devices.

Accordingly, various embodiments are directed to a hotspot accessory camera/hotspot accessory camera system comprising a camera designed to be an accessory device and connectable to a hotspot via a physical, e.g., USB, connection. The physical connection, although not necessary, is preferred as it preserves WiFi capacity of the hotspot. The USB connection can be effectuated with a USB port/connector to which the hotspot can directly connect.

In some embodiments, the camera and/or the hotspot device can be designed with edge processing and artificial intelligence (Al) capabilities for video processing, e.g., analyzing video to detect various elements of a real-world scene, to perform data analytics, etc. Edge processing limits 5G data transmission to a cloud server, e.g., cloud server 210 (resulting in cost savings to a user). Moreover, only meaningful alerts/notifications are sent as a result of the edge processing (versus, e.g., transmitting all captured video to a cloud server to be analyzed). The amount of processing power/intelligence can vary through, e.g., the use of lower-end cameras and higher-end cameras. In some embodiments, the contemplated camera system can be adapted to work with other fixed wireless access (FWA) devices.

Such a hotspot accessory camera system may include a base or “dock” that accepts a hotspot device, and an arm that holds one or more cameras, the arm being designed to be rotatable or otherwise actuatable (for security/greater FOV, and storage), and to allow cameras to be moved up and down. In some embodiments, the hotspot accessory camera may be embodied as part of a dock that includes a minimal clip-on design that mitigates hotspot device antenna(s) disruption. The base can be designed to accommodate different hotspot devices, and/or cameras, as well as other accessories, e.g., smart speakers, gaming, AR/VR accessories, etc.

In this way, hotspots can be transformed into more than just a mobile router or access point, and can be part of an end-to-end solution. For example, in a factory setting, a hotspot with an accessory camera or hotspot accessory camera system can be connected to machinery, and used to monitor attached sensor values locally, quickly, and without incurring 4G or 5G wireless data costs until a sensor reaches some threshold value, at which time an alert can be sent out. Alternatively, a hotspot with an accessory camera can monitor a scene, environment, etc., and can be triggered via the detection of motion or a person, for example.

It should be noted that merely adding more processing power and/or memory to a hotspot can add significant expense to that hotspot. The use of an accessory camera allows flexibility of use and configuration of a hotspot that need not be designed and manufactured specifically with a camera/imaging capabilities. In this way, a hotspot can be used as a hotspot accessory camera system when desired, and when not, the hotspot can be used on its own. FIG. 2B illustrates an example system, similar to that of FIG. 2A, where hotspot 200 may be operatively connected to a hotspot accessory camera 220. Myriad use-case scenarios, some of which have been noted above, are contemplated using a hotspot accessory camera system.

For example, cloud server 210 may be a cloud-based targeted advertising server from which targeted advertisements can be sent to users. In accordance with one embodiment, hotspot 200 may be operatively connected to an accessory camera 220, the combination comprising a hotspot accessory camera system that can be used by user devices 202 and 204 to connect to/communicate/interface with the Internet (communications network 208). Accessory camera 220 may have monitoring and processing capabilities to discern certain activities being performed or in which users of user devices 202, 204 may be engaged. While a conventional hotspot may be aware of user device identities of user devices 202, 204, with the addition of camera accessory 220, information regarding what a user of user devices 202, 204 and/or the context in which these users are interacting with user devices 202, 204 may be determined. Accessory camera 220 may determine (by capturing one or real-time images/video) that the user of user device 202 is facing a particular business while accessing the website associated with the business. This information can be transmitted to cloud server 210 which may then transmit targeted advertising regarding the business which the user is facing.

Similarly, accessory camera 220, via image capture of the user of user device 204, may sense the user's facial expressions or other biometric indicators and combine or compare or otherwise relate that sensed information to the data/communications being transceived through hotspot 200. That information may then be processed by accessory camera 220 (which may have certain Al, data analytics, and/or other processing capabilities resident therein) to filter out irrelevant/duplicative images, information, etc. and send a relevant information subset of data/dataset to cloud server 210. For example, it may be discerned by accessory camera 220 that the user of user device 204 is laughing while streaming comedy videos to user device 204. Cloud server 210 may be a media or content server that, based on the received information from camera 220, can discover and present related/similar content or notify user of user device 204 of such content.

Still another example may be in a rideshare context, whereby a hotspot accessory camera system may be deployed in a vehicle being used for rideshare services. More streamlined and/or more secure payment operations can be effectuated through the use a hotspot accessory camera system in this context. That is, accessory camera 220 can be used to identify and authenticate a user associated with user device 202 that is currently associated with a rideshare program and payment therefore. Upon entry into a vehicle in which the hotspot accessory camera is deployed, a user device identifier associated with user device 202 can be compared to previously-provided visual/facial identification image(s) of the user authorized to use user device 202/associated with a user subscriber account related to user device 202. That is, information/data gleaned by accessory camera 220 can be transmitted to cloud server 210, which may be an authentication server. This can help ensure the safety of the rideshare service driver (to ensure the identity of the user of user device 202 entering/that has entered the vehicle). Such a hotspot accessory camera system may be used in the converse as well, where the hotspot accessory camera system may, under control of a rideshare provider, be securedly deployed. In this way, a rideshare user can be ensured of the identity of the rideshare service driver prior to entering a vehicle.

Various embodiments of the disclosed technology can be used to effectuate similar or alternative actions/operations depending on various scenarios or situations in which a hotspot accessory camera system is deployed and used.

Although various embodiments may be described in terms of this example environment, the technology disclosed herein can be implemented in any of a number of different environments. Again, on-the-go 5G mobile video/imaging can be achieved to enable video conferencing, video event camming/streaming, video surveillance/monitoring, rideshare/drive cam functionality, etc. As also noted above, certain functionality/processing can be pushed to the edge (at the hotspot accessory camera system) to avoid possibly high costs associated with cellular data transmission.

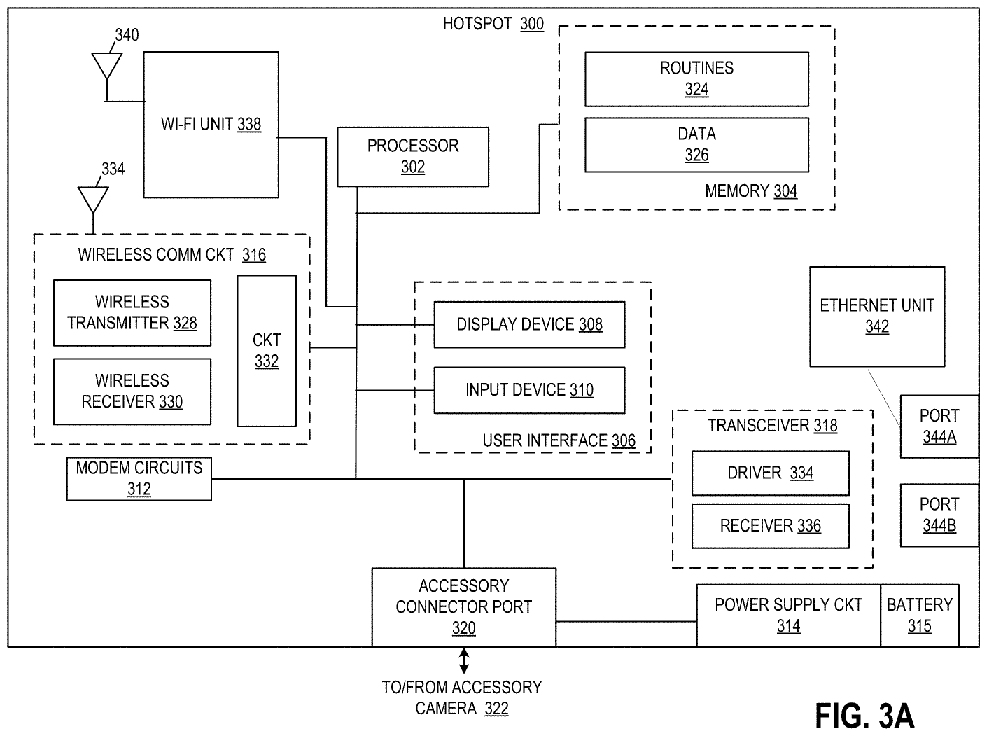

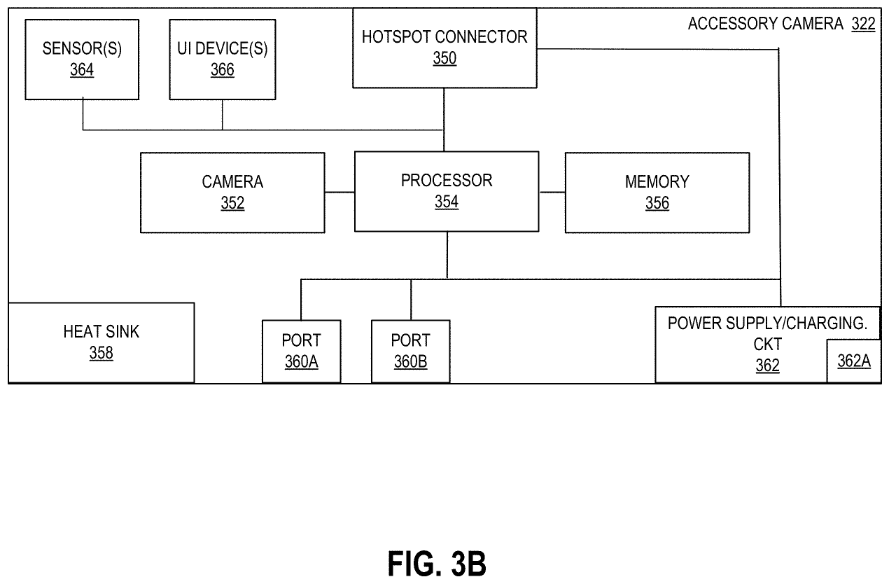

FIG. 3A is a schematic representation of an example hotspot 300, e.g., a 5G hotspot. Hotspot 300 may include a processor 302, a memory 304, user interface(s) 306 which may be in the form of a display device 308 and an input device 310, modem circuits 312, power supply circuit(s) 314, a 5G wireless communication circuit 316, an accessory connector port 320, and a WiFi unit or circuitry 330.

Processor 302 may be implemented as a dedicated or general-purpose processor or combination of processors or computing devices to carry out instructions and process data. For example, processor 302 may access memory 304 to carry out instructions, including routines 324, using data including data 326. Processor 302 may include one or more single core, dual core, quad core or other multi-core processors. Processor 302 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processing device. The aforementioned Al, data analytics, monitoring, and/or other functionalities can be realized via processor 302, or at least in part, via processor 302. Other modem circuits 312 may be provided to perform other modem functions.

Memory 304 includes memory locations for storing instructions or other routines 324 and data 326. Memory 304 may be implemented using any machine-readable or computer-readable media to store data and instructions, including volatile and nonvolatile memory. Memory 304 may be implemented, for example, as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory or other solid state memory, polymer memory, ferroelectric memory, silicon-oxide-nitride-oxide-silicon (SONOS) memory, holographic or other optical storage, or other memory structures. Although memory 304 is illustrated as a separate component in FIG. 3A, part or all of memory 304 can be implemented on the same integrated circuit as processor 302 or otherwise form part or all of embedded memory of processor 302.

Wireless communication circuit 316 may include a wireless transmitter 312, a wireless receiver 330, communication circuitry 332 and antenna 334 (to effectuate communications between hotspot 300 and a serving GnB(s). Communication circuitry 332 may be implemented as a communications processor using any suitable processor logic device to provide appropriate communications operations such as, for example, baseband processing, modulation and demodulation, and other wireless communication operations. Where certain operations such as modulation and demodulation are performed in the digital domain, analog-to-digital and digital-to-analog conversion circuitry can be included to provide the appropriate interfaces between communication circuitry 332 and wireless transmitter 328/wireless receiver 330.

Transceiver 318 may be included to provide a hardwired communications interface between hotspot 300 and an accessory, e.g., an accessory camera 322 (which will be described below) to provide data connectivity therebetween. The illustrated example includes a driver circuit 334 to transmit data to accessory camera 322 and a receiver circuit for 336 to receive data from accessory camera 322 or one or more network elements/devices operatively connected to hotspot 300. Using transceiver 318, data received from the 5G network intended for devices served by, e.g., a Wi-Fi unit such as WiFi unit 338 (described below), can be transferred to Wi-Fi unit 338. Similarly, transceiver 318 can receive data from devices served by the Wi-Fi into 338, and provide that data to other components of hotspot 300 for processing and transmission to the 5G network via wireless communications circuit 316.

The user interface 306 in this example may include a display device 308 and an input device 310. Display device 308 may include, for example, one or more LEDs, display screens, touch screens, or other alphanumeric displays, or other display devices to communicate data or other information to a user. Input device 310 may include buttons, a keypad, a touchscreen display, or other input device to accept input from a user. In some embodiments, display device 308 may be include audio-based presentation circuitry to present information/content via audio/audible tones or queues, etc. Display device 308 and input device 310 may include attendant circuitry such as drivers, receivers and processing or control circuitry to enable operation of the devices with hotspot 300.

User interface 306 can provide a user interface to control operation of hotspot 300. It should be noted that user interface 306 is optional, and hotspot 300 need not have a user interface. A user of hotspot 300 may interact, e.g., control or configure hotspot 300 via a computing device operatively connected to hotspot 300 through wireless communications circuit 316. For example, user interface 306 may also be implemented using a separate device such as an application running on a smart phone, tablet, or other computing system. Accordingly, user interface 306 may include a wired or wireless communication interface to communicate with the smart phone, tablet or computing system running the application.

Power supply circuit(s) interface (I/F) 314 can be included to receive power provided from an external power source such as, for example, an AC mains circuit of the building via the USB connector directly, or via the USB connector by way of AC mains circuit indirectly when connected to accessory camera 322. Otherwise, hotspot 300 may be powered via a battery or similar power source 315. As will be described below, accessory camera 322 may comprise its own power supply/charging circuit that can include a switch/distribution circuit that route power to hotspot 300 and accessory camera 322 when hotspot 300 is operatively connected to accessory camera 322, and accessory camera is being powered, e.g., via the AC mains. Alternatively, if accessory camera 322 is not connected to the AC mains or other external power source, accessory camera 322 may draw power from battery 315 of hotspot 300 vis-a-vis power supply circuit 314.

Wi-Fi unit 336 may be embodied as a Wi-Fi router. Wi-Fi unit 336 allows for the transmission/reception of data to/from the Internet or other data network on behalf of user devices (e.g., laptop computers, table computers, smartphones, etc.) through connectivity provided by hotspot 300 via wireless communications circuit 316. It should be noted that Wi-Fi unit 336 is only an example, and other wireless routers, for example, may be implemented in accessory camera 322 to provide wireless connectivity/data transfer.

Another example of such networking functionality includes, e.g., Ethernet unit 342, which may be embodied as an Ethernet hub or switch. Ethernet unit 342 allows for a wired connection between a device(s) and hotspot 300. One or more of ports 344 (344A, 344B) may be Ethernet LAN/RJ45 ports, Universal Serial Bus (USB) ports, WAN ports, etc. It should be noted that there may more or less ports that those illustrated in FIG. 3 to accommodate varying needs/desired hotspot configurations.

Accessory connector port 320 may be a data connector port, allowing for the exchange of data between hotspot 300 and accessory camera 322 (or other devices/accessories that can connect to hotspot 300). Accessory connector port 320 may be a USB port for operatively receiving a USB connector, such as one implemented on accessory camera 322.

FIG. 3B illustrates a schematic representation of accessory camera 322 that may be operatively connected to hotspot 300 to provide additional functionality to hotspot 300, e.g., provide Al edge processing functionality, data analytics functionality, image verification/authentication functionality, etc. As illustrated in FIG. 3B, accessory camera 322 may include a hotspot connector 350. Hotspot connector 350 may be a corresponding connector, e.g., USB connector configured to be received by/mate with accessory camera connector port 320 of hotspot 300. That is, accessory camera connector 320 may mate with hotspot connector 350 to physically and operationally connect hotspot 300 and accessory camera 322.

It should be understood (and as will be discussed in greater detail below), accessory camera 322 may be configured to matingly hold hotspot 300. That is, accessory camera 322 may act as an accessory dock in addition providing camera (and other processing functionality as alluded to above).

Accessory camera 322 may include a camera unit 352, which may be any type of camera appropriately sized to be used an accessory to a hotspot, such as hotspot 300, and which may embody a video camera, a still camera, a 360-degree rotatable camera, etc. The particular configuration of camera unit 352 can vary depending on manufacturer needs/desires, consumer needs/desires, etc. Camera unit 352 may be capable of capturing video/images at a particular resolution and/or frame rate, or may have variable resolution/frame rate, camera unit 352 may have a particular len(s) configuration, e.g., zoom, wide-angle, etc. Camera unit 352 may be capable of night-vision, i.e., infrared/low light sensing. Camera unit 352 may be capable of stitching images, capturing panoramic views, etc. It should be noted that camera unit 352 may store recorded images/video on a memory 356, which can be internal memory and/or removable memory, such as a microSD card. Accordingly, memory 356 may include a microSD memory slot or other commensurate type of memory slot. In some embodiments, one of ports 360 (360A, 360B) may comprise another USB port to which a flash memory device may be connected. In some embodiments, accessory camera 322 may be configured/controlled, or memory may be accessed directly through user device connected thereto. For example, upon disconnection from hotspot 300, a user can review data collected by accessory camera 322, perform offline processing of the collected data, then connect hotspot 300 back to accessory camera 322, and via hotspot 300, “revised” or processed data can be uploaded to cloud server 210.

Processor 354 may be implemented as a dedicated or general-purpose processor or combination of processors or computing devices to carry out instructions and process data. For example, processor 354 may access memory 356 to carry out instructions, including routines, using data including data (similar to processor 302/memory 304). Processor 354 may include one or more single core, dual core, quad core or other multi-core processors. Processor 354 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processing device. The aforementioned AI, data analytics, monitoring, and/or other functionalities can be realized via processor 354 instead of or in addition to that realized by processor 302 of hotspot 300.

Memory 356 includes memory locations for storing instructions or other routines and data, such as captured images/video from camera unit 352 and/or other data or information. In some embodiments, memory 356 may include instructions for executing a machine learning/Al model or neural network. Memory 356, like memory 304, may be implemented using any machine-readable or computer-readable media to store data and instructions, including volatile and nonvolatile memory. Memory 356 may be implemented, for example, as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory or other solid state memory, polymer memory, ferroelectric memory, silicon-oxide-nitride-oxide-silicon (SONOS) memory, holographic or other optical storage, or other memory structures. Although memory 356 is illustrated as a separate component in FIG. 3B, part or all of memory 356 can be implemented on the same integrated circuit as processor 354 or otherwise form part or all of embedded memory of processor 354. In some embodiments, memory 356 may act as a cache or buffer for captured images/video or other data prior to transmission and/or storage to a remotely located element or storage, e.g., cloud server 210 (FIG. 2B).

Connectivity, location-based information/services, and the like can be effectuated vis-a-vis hotspot 300. That is, processor 354 may process images captured by camera unit 352 by appending time/date/location information relevant to the captured images. Such information may be received by processor 354 from hotspot 300. In some embodiments control signals or other commands may be sent to accessory camera 322 via hotspot connector 350.

Accessory camera 322 may further include one or more sensors 364, such as a GPS sensor/receiver for obtaining the above-noted location-based information associated with, e.g., captured images/video. In some embodiments the one or more sensors 364 may include one or more accelerometers for sensing movement, for providing information on which image stabilization of camera unit 352 can be based, and so on. In some embodiments sensor 364 may comprise environmental sensors that can be triggered by certain environmental conditions. In some embodiments, an accelerometer may be used as a triggering sensor, e.g., in the case of vehicle deployment, sudden movement/level of movement and/or acceleration/deceleration can signify a road event that may warrant image/video capture, e.g., to support accident reporting, insurance incident reporting, etc.

Further still, accessory camera 322 may include one or more user interface (UI) devices 366, such as a display, a touchscreen, one or more physical buttons, soft buttons, indicator/status light emitting diodes (LEDs), etc. with which a user may interact with/control/manage the operation of accessory camera 352. UI devices 366 may further or alternatively include audio devices, e.g., one or more microphones, speakers, etc. for effectuating voice-based control/interaction with accessory camera 322. In some embodiments, camera unit 352 may include a voice-based assistant or agent through which/with which a user of accessory camera can interact.

In some embodiments, accessory camera 322 may include a heat sink 358 for dissipating heat from accessory camera 322 componentry and/or heat from hotspot 300. It should be understood that the example heat sink 358 as illustrated is not necessarily representative of size/placement in accessory camera 322. That is, heat sink 358 may be larger, e.g., to cover, surround, or abut one or more heat-generating elements of accessory camera 322 e.g., camera unit 352, processor 354, sensor(s) 364, as well as a bottom surface of hotspot 300 that abuts a surface of a housing (described below) surrounding/encapsulating the components of accessory camera 322. In some embodiments, multiple heat sinks may be utilized (not shown) to dissipate heat from heat-generating elements of hotspot 300 and/or accessory camera 322. As is understood by those of ordinary skill in the art, a heat sink, such as heat sink 340 increases heat flow away from a heat-generating element or device by increasing that element's surface area.

In some embodiments, heat sink 358 may comprise or may be operatively connected to a conductor (also referred to as a thermal interface material) made of heat conducting material(s), e.g., aluminum alloys, copper, and/or other material(s) known now or in the future. Such a conductor may be used to move heat from a heat-generating element away from the heat-generating element to protrusions, typically fins that make up heat sink 358. The fins may vary in terms of height, width, configuration, and/or separation between adjacent fins depending on the amount of cooling needed/desired in hotspot 300/accessory camera 322. Heat sink 358 as currently illustrated comprises a passive heat sink, although in other embodiments, heat sink 358 may be implemented as an active heat sink with, e.g., an attached fan (not shown) to assist in heat dissipation, or a hybrid heat sink.

Accessory camera 322 may also comprise a power supply circuit(s) 362 to provide power conditioning or power conversion for components of accessory camera 322 as well as hotspot 300 (if desired and if hotspot 300 is connected thereto) as well as any components resident therein, e.g., Wi-Fi unit 338 of hotspot 300, camera unit 352 of accessory camera 322, etc. For example, power supply circuit(s) 362 can supply power to different components of hotspot 300 and accessory camera 322 at specific voltage and current levels appropriate for those components. Power supply circuit(s) 362 in this example, may receive power from an external power source such as, for example, an AC mains circuit of the building, or may include a power source, such as one or more battery units (not shown). In some embodiments, when power supply circuit(s) 362 is connected to the AC mains circuit, power is routed through power supply circuit(s) 362 which may include a distribution circuit or switch 362A that can power accessory camera 322, and powers power supply circuit 314 of hotspot 300 via hotspot connector 350. If not connected to an external power source, accessory camera 322 may draw power from hotspot 300 via hotspot connector 350.

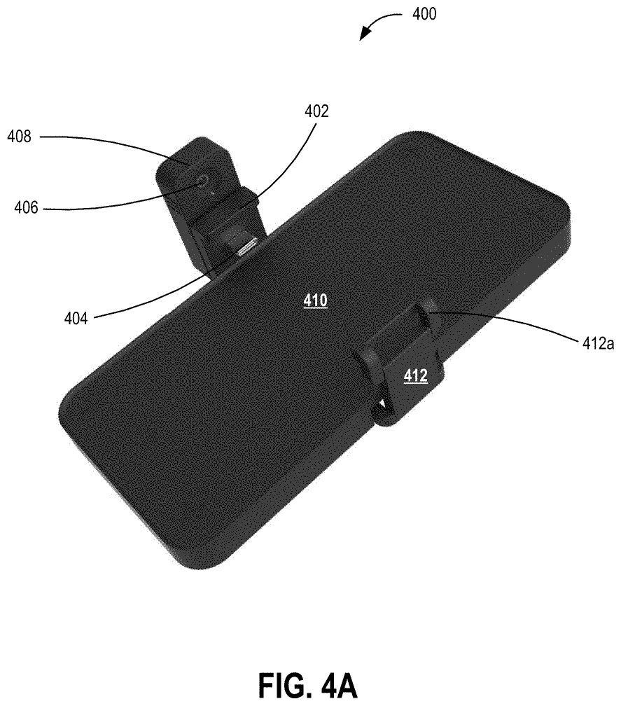

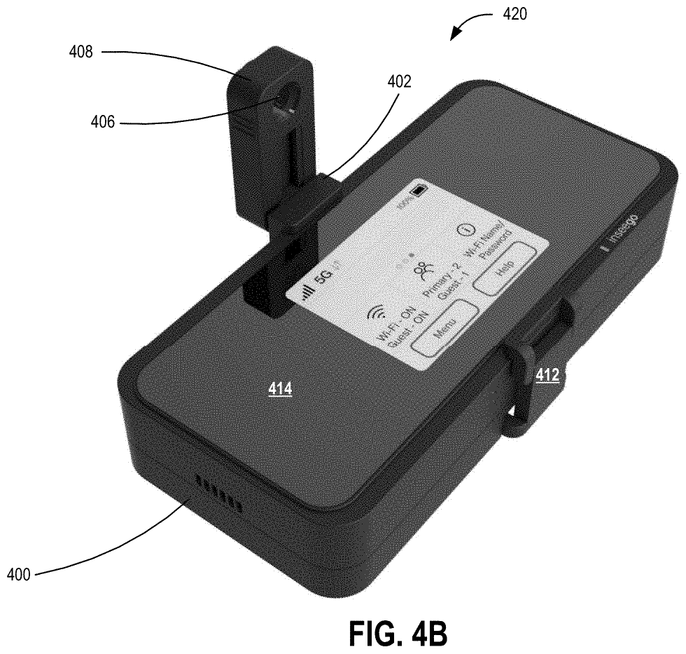

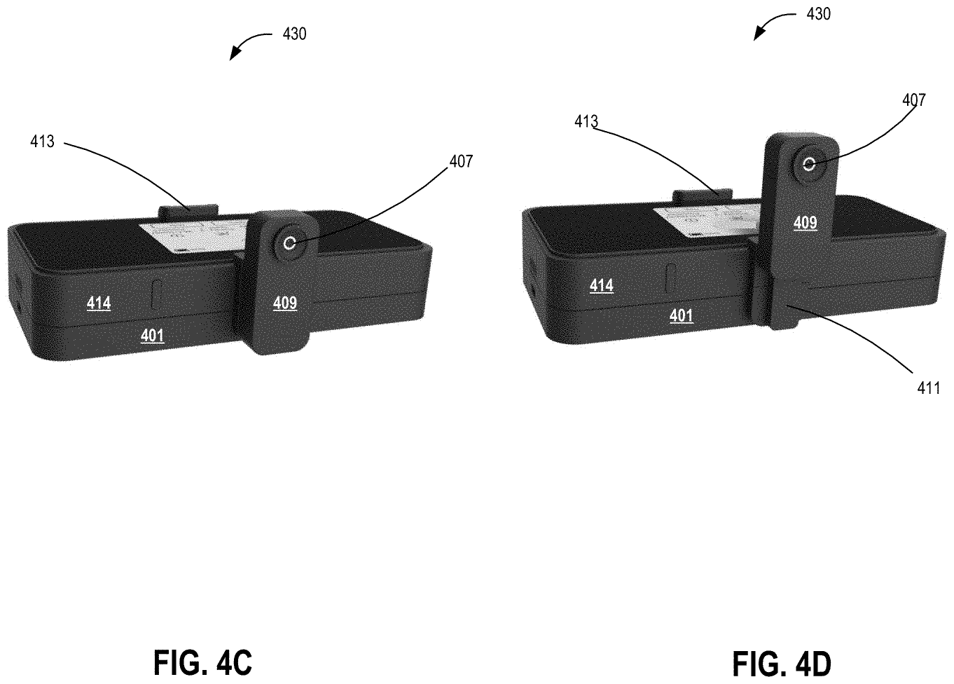

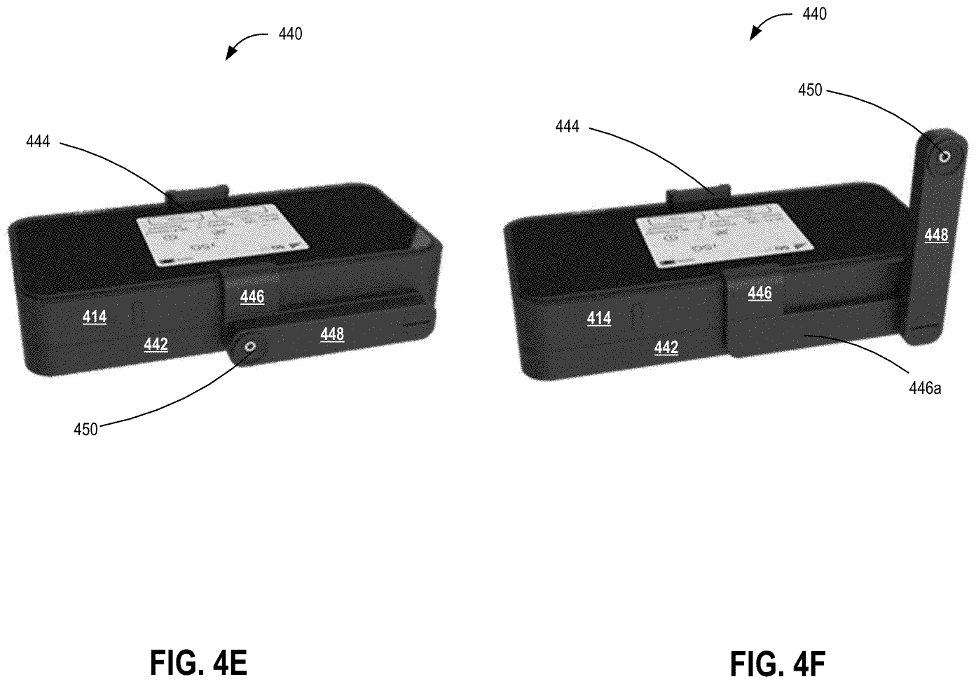

FIG. 4A illustrates an example accessory camera 400 in accordance with one embodiment. FIG. 4B illustrates an overhead perspective view of an example hotspot accessory camera system in accordance with one embodiment.

As illustrated in FIG. 4A, accessory camera 400, which may be an embodiment of accessory camera 200 or 322, and may comprise a base or support platform 410. Support platform 410 may be configured to support a bottom surface of a hotspot 414 (shown in FIG. 4B). It should be understood that the illustrated shape and/or size of support platform 410 (in addition to other aspects of accessory camera 400) can vary. For example, support platform 410 may be sized to accept a variety of different hotspots, and/or may be shaped to provide support in various ways. For example, in the illustrated embodiment, an outer perimeter of support platform 410 may be flush with an outer perimeter of hotspot 414 such that a resulting accessory camera system 420 (comprising accessory camera 400 operatively attached to or combined with hotspot 414) appears to be relatively monolithic in appearance. In other words, the footprints of both hotspot 414 and support platform 410 may be the same/substantially similar in size/shape. In other embodiments, support platform 410 may be sized to be large enough to support a plurality of different sized hotspots. In other embodiments, support platform 410 may be configured to include other supporting structure(s) or element(s), such as a one or more protrusions that more securely capture hotspot 414.

In some embodiments, accessory camera 400 may comprise a retaining latch 412. Retaining latch 412, may, in some embodiments, comprise a spring-loaded hinged member or lip 412a that extends from one end of retaining latch 412 and substantially cups a perimeter edge of hotspot 414 (see FIG. 4B). It should be noted that other retaining mechanisms (known currently or in the future) are contemplated in accordance with other embodiments. In some embodiments, a retaining latch 412 need not be used. For example, at an opposite edge of support platform 410, another retaining member 402 may be used (on its own, or in conjunction with retaining latch 412) to secure hotspot 414 onto support platform 410. It should also be noted that although FIGS. 4A and 4B illustrate retaining latch 412 and retaining member 402 as being disposed on opposite edges along the longer sides of support platform 410, one or more such retaining elements may be disposed elsewhere along the perimeter edge of support platform 410 (or at other locations therein/thereon, not necessarily at the edge(s)).

As discussed above, an accessory camera may comprise a hotspot connector, which in some embodiments, and as illustrated in FIG. 4A, a USB connector, in particular a USB type C connector 404 (although other connectors whether USB or other format) are contemplated. USB type C connector 404 may be an embodiment of hotspot connector 350 (FIG. 3B). It should be appreciated that when connecting hotspot 414 to support platform 410, retaining latch 412 may be actuated (e.g., pried away from retaining member 402 to allow an accessory camera connector port to receive/mate with USB type C connector 404. Upon releasing retaining latch 412, hotspot 414 is securedly connected to accessory camera 400.

Accessory camera may further comprise a camera unit 406 (which may be an embodiment of camera unit 354 (FIG. 3), and may be implemented in or as part of an arm 408. Arm 408 may not only support camera unit 406, but may further be configured as an on/off switching mechanism. For example, in FIG. 4A, arm 408 is illustrated in an off (down) position. In FIG. 4B, arm 408 is illustrated as being in an on (up/raised) position, upon connection to hotspot 414.

FIG. 4C illustrates a rear perspective view of an example hotspot accessory camera system 430 in an on state in accordance with one embodiment. FIG. 4D illustrates a rear perspective view of the example hotspot accessory camera system 430 of FIG. 4C in an off state in accordance with one embodiment. As can be appreciated, in this embodiment, accessory camera 401 may be configured with a similar base or support platform (as that of FIGS. 4A, 4B), and a similar arm 409, and retaining latch 413. However, in this embodiment, accessory camera 401 further comprises a second camera unit 407 disposed/configured to capture images/video in a direction opposite that of a first camera unit facing the direction of hotspot 414 (not shown). In this way, data from more than one perspective/direction can be captured. It should be understood that the number of camera units and/or their positioning/location can vary in accordance with other embodiments. In some embodiments, as alluded to above, an incorporated camera unit may provide a 360-degree view. Thus, in some embodiments, a camera unit(s) may be disposed on a rotating gimble/mechanism (not shown). FIG. 4D illustrates a track 411 on which arm 409 may be raised/lowered to turn accessory camera 401 on/off.

FIG. 4E illustrates a rear perspective view of an example hotspot accessory camera system 440 in an on state in accordance with one embodiment. FIG. 4F illustrates a rear perspective view of the example hotspot accessory camera system 440 in an off state in accordance with one embodiment. FIGS. 4E and 4F illustrate yet another embodiment of an accessory camera system. As illustrated in FIGS. 4E and 4F, accessory camera 442 may have a support platform and retaining latch 444 and retaining member 446. However, in this embodiment, arm 448 is actuatable in an arcuate path such that arm 448 can be swung upwards (from an off/down position as illustrated in FIG. 4E) and over (to an on/up position as illustrated in FIG. 4F). In this way, when in the off/down position, camera unit 450 may be positioned in line with retaining member 446 and arm 448 is parallel to arm 446a. In the on/up position, camera unit 450 is oriented pivotally away from retaining member 446 and perpendicular to arm 446a.

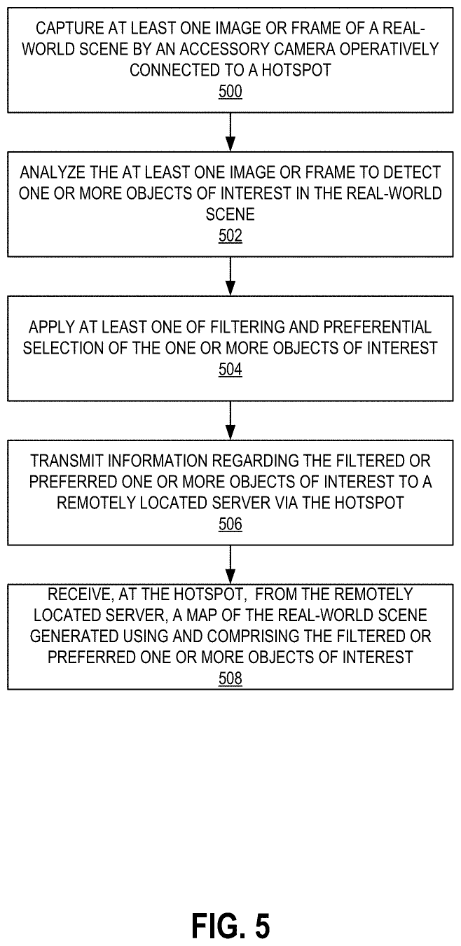

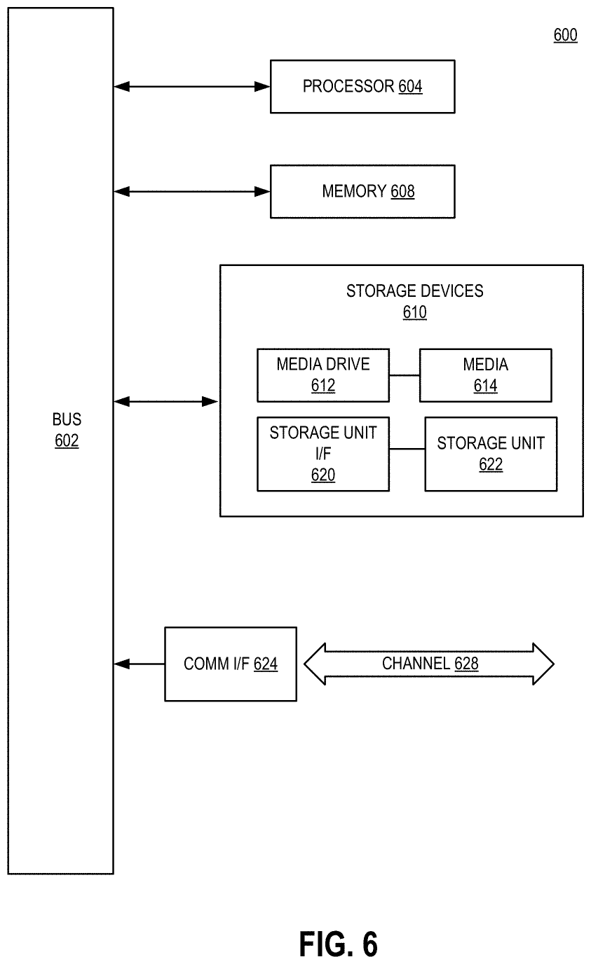

FIG. 5A is a flow chart illustrating example operations for creating a map that can be used to guide a self-installation process of a FWA device, or to optimally locate a hotspot relative to one or more GnBs of a 5G network. At operation 500, at least one image or frame of a real-world scene is captured by an accessory camera operatively connected to a hotspot. As described above, in accordance with various embodiments, a hotspot accessory camera system may comprise a hotspot operatively connected to an accessory camera, where images/video or other captured data (e.g., audio data from an audio input/output unit, sensor, mechanism, etc.) can be analyzed at the accessory camera.

In this embodiment, the analysis comprises analyzing the at least image or frame to detect one or more objects of interest in the real world scene at operation 502. The detection of one or more objects of interest may be the detection of walls, obstacles, occluding objects preventing clean/clear line of sight from a particular location to a 5G GnB. As noted above, while 5G technology can provide increased speed and bandwidth, the millimeter wave signals are very sensitive to obstructions, and thus, optimal placement of FWAs (or a hotspot) can be advantageous to achieving desired performance.

At operation 504, one of filtering and preferential selection of the one or more objects of interest can be applied. That is, at the edge, e.g., at the accessory camera, processing can be performed on the captured images or frames to identity only those objects that would be relevant to include in map of the location. In this way, irrelevant data/noise can be filtered out prior to transmission to map generation service/server (e.g., cloud server 210) via the hotspot. Bandwidth and resources can be saved, and cost of transmission can be reduced by only sending relevant information to the cloud. For example, information regarding/reflecting only the occluding objects may be cached in local memory, e.g., memory 356 of access camera 322 (FIG. 3B), and/or in memory 304 of hotspot 300 prior to transmission (described below) to a cloud-based server/processor that may further process/use/perform one or more actions based thereon/etc.

At operation 506, therefore, information regarding the filtered or preferred one or more objects of interest can be transmitted to a remotely located server via the hotspot to which the accessory camera is operatively connected. That same hotspot, at operation 408, may receive, from the remotely located server, a map of the real-world scene can be generated comprising the filtered or preferred one or more objects of interest.

The terms “substantially” and “about” used throughout this disclosure, including the claims, are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The term “coupled” refers to direct or indirect joining, connecting, fastening, contacting or linking, and may refer to various forms of coupling such as physical, optical, electrical, fluidic, mechanical, chemical, magnetic, electromagnetic, optical, communicative or other coupling, or a combination of the foregoing. Where one form of coupling is specified, this does not imply that other forms of coupling are excluded. For example, one component physically coupled to another component may reference physical attachment of or contact between the two components (directly or indirectly), but does not exclude other forms of coupling between the components such as, for example, a communications link (e.g., an RF or optical link) also communicatively coupling the two components. Likewise, the various terms themselves are not intended to be mutually exclusive. For example, a fluidic coupling, magnetic coupling or a mechanical coupling, among others, may be a form of physical coupling.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. In other words, as would be apparent to one of ordinary skill in the art after reading this description, the various features and functionality described herein may be implemented in any given application and can be implemented in one or more separate or shared circuits in various combinations and permutations. Even though various features or elements of functionality may be individually described or claimed as separate circuits, one of ordinary skill in the art will understand that these features and functionality can be shared among one or more common circuits, and such description shall not require or imply that separate circuits are required to implement such features or functionality.

Where circuits are implemented in whole or in part using software, in one embodiment, these software elements can be implemented to operate with a computing or processing system capable of carrying out the functionality described with respect thereto. One such example computing system is shown in FIG. 8. Various embodiments are described in terms of this example-computing system 600. After reading this description, it will become apparent to a person skilled in the relevant art how to implement the technology using other computing systems or architectures.

Referring now to FIG. 8, computing system 600 may represent, for example, computing or processing capabilities found within desktop, laptop and notebook computers; hand-held computing devices (smart phones, cell phones, palmtops, tablets, etc.); mainframes, supercomputers, workstations or servers; or any other type of special-purpose or general-purpose computing devices as may be desirable or appropriate for a given application or environment. Computing system 600 might also represent computing capabilities embedded within or otherwise available to a given device. For example, a computing system might be found in other electronic devices such as, for example, digital cameras, navigation systems, cellular telephones, portable computing devices, modems, routers, WAPs, terminals and other electronic devices that might include some form of processing capability.

Computing system 600 might include, for example, one or more processors, controllers, control modules, or other processing devices, such as a processor 604. Processor 604 might be implemented using a general-purpose or special-purpose processing engine such as, for example, a microprocessor (whether single-, dual- or multi-core processor), signal processor, graphics processor (e.g., GPU) controller, or other control logic. In the illustrated example, processor 604 is connected to a bus 602, although any communication medium can be used to facilitate interaction with other components of computing system 600 or to communicate externally.

Computing system 600 might also include one or more memory modules, simply referred to herein as main memory 608. For example, in some embodiments random access memory (RAM) or other dynamic memory, might be used for storing information and instructions to be executed by processor 604. Main memory 608 might also be used for storing temporary variables or other intermediate information during execution of instructions to be executed by processor 604. Computing system 600 might likewise include a read only memory (“ROM”) or other static storage device coupled to bus 602 for storing static information and instructions for processor 604.

The computing system 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a floppy disk drive, a magnetic tape drive, an optical disk drive, a CD or DVD drive (R or RW), a flash drive, or other removable or fixed media drive might be provided. Accordingly, storage media 614 might include, for example, a hard disk, a floppy disk, magnetic tape, cartridge, optical disk, a CD or DVD, or other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing system 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory module) and memory slot, a flash drive and associated slot (for example, a USB drive), a PCMCIA slot and card, and other fixed or removable storage units 622 and interfaces 620 that allow software and data to be transferred from the storage unit 622 to computing system 600.

Computing system 600 might also include a communications interface 624. Communications interface 624 might be used to allow software and data to be transferred between computing system 600 and external devices. Examples of communications interface 624 might include a modem or softmodem, a network interface (such as an Ethernet, network interface card, WiMedia, IEEE 802.XX, Bluetooth® or other interface), a communications port (such as for example, a USB port, IR port, RS232 port, or other port), or other communications interface. Software and data transferred via communications interface 624 might typically be carried on signals, which can be electronic, electromagnetic (which includes optical) or other signals capable of being exchanged by a given communications interface 624. These signals might be provided to communications interface 624 via a channel 628. This channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 608, storage unit 622, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing system 600 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various example embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described example embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of example block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
capturing at least one image or frame of a real-world scene by an accessory camera operatively connected to a hotspot;
analyzing the at one image or frame to detect one or more objects in the real-world scene;
applying at least one of filtering and preferential selection of the one or more objects of interest;
transmitting information regarding the filtered or preferred one or more objects of interest to a remotely located server via the hotspot; and
receiving, at the hotspot, from the remotely located server, a map of the real-world scene generated using and comprising the filtered or preferred one or more objects of interest.

2. The method of claim 1, wherein the one or more detected objects include, in part, occluding objects impeding line-of-sight connectivity between the hotspot and a 5G small cell.

3. The method of claim 2, wherein the application of the at least one of filtering and preferential selection comprises identifying only the occluding objects.

4. The method of claim 3, further comprising caching the occluding objects in a memory of at least one of the hotspot and the accessory camera.

5. A hotspot accessory camera system, comprising:
a hotspot; and
an accessory camera operatively connected to the hotspot, the accessory camera comprising:
a support platform supporting a surface of the hotspot thereon;
at least one retaining member securedly retaining the hotspot to the support platform;
a hotspot connector mating with an accessory camera connector port effectuating a data connection between the hotspot and the accessory camera;
an actuatable arm; and
a camera unit disposed in the actuatable arm capturing at least one of images and frames, wherein at least a subset of the at least one of the images and frames are received by the hotspot for transmission to a remote server via a communications connection effectuated between the hotspot and a wireless communications network.

6. The hotspot accessory camera system of claim 5, wherein the camera unit comprises first and second camera lenses oriented to capture the at least one of the images and frames from at least two directions.

7. The hotspot accessory camera system of claim 5, wherein the accessory camera further comprises at least one processor adapted to perform edge processing at the accessory camera prior to the transferring of the at least one of the images and frames to the remote server.

8. The hotspot accessory camera system of claim 7, wherein the at least one processor adapted to perform the edge processing filters one or more of the at least one of the images and frames.

9. The hotspot accessory camera system of claim 8, wherein the subset of the at least one of the images and frames comprises those of the one or more of the at least one of the images and frames remaining after the filtering by the at least one processor.

10. The hotspot accessory camera system of claim 9, wherein the at least one processor is further adapted to cache the subset of the at least one of the images and frames in a memory of at least one of the hotspot and the accessory camera.

11. The hotspot accessory camera system of claim 8, wherein the at least one of the images and frames includes facial captures from one or more users of the hotspot accessory camera system.

12. The hotspot accessory camera system of claim 12, wherein the at least one processor adapted to perform the edge processing filters the at least one of the images and frames to store only those of the at least one of the images and frames corresponding to the facial captures from the one or more users of the hotspot accessory camera system.

13. The hotspot accessory camera system of claim 12, wherein the hotspot transmits the facial captures from the one or more users of the hotspot accessory camera system to the remote server to authenticate the one or more users.

14. The hotspot accessory camera system of claim 7, wherein the accessory camera further comprises one or more sensors sensing biometric-related characteristics of one or more users of the hotspot accessory camera system.

15. The hotspot accessory camera system of claim 15, wherein the processor is further adapted to relate the biometric-related characteristics of the one or more users to the at least one of the images and frames.

16. The hotspot accessory camera system of claim 16, wherein the hotspot receives targeted data for presentation to the one or more users based on the relationship between the biometric-related characteristics and the at least one of the images and frames.
